(19) United States
(12) Patent Application Publication
(10) Pub. No.: US 2012/0307895 A1
(43) Pub. Date: Dec. 6, 2012

(54) IMAGE-ENCODING APPARATUS AND METHOD, TRANSFORM-ENCODING APPARATUS AND METHOD, APPARATUS AND METHOD FOR GENERATING A TRANSFORM BASE, AND IMAGE-DECODING APPARATUS AND METHOD USED IN SAME

(75) Inventors: Sunyeon Kim, Seoul (KR); Jeongyeon Lim, Gyeonggi-do (KR); Gyumin Lee, Gyeonggi-do (KR); Jaehoon Choi, Gyeonggi-do (KR); Yonggoo Kim, Seoul (KR); Yoonsik Choe, Seoul (KR); Yungho Choi, Seoul (KR)

(73) Assignee: SK TELECOM CO., LTD., Seoul (KR)

(21) Appl. No.: 13/514,552

(22) PCT Filed: Dec. 9, 2010
(86) PCT No.: PCT/KR2010/008777

§ 371 Date: Aug. 27, 2012

(30) Foreign Application Priority Data
Dec. 9, 2009 (KR) 10-2009-0121980

(51) Int. Cl. H04N 7/50

(52) U.S. Cl. 375/240.12; 375/E07.211

(57) ABSTRACT

A video encoding apparatus includes an intra prediction error collector; a transform base generator; an intra predictor; and a transform encoder, the intra prediction error collector collecting prediction errors of blocks having an equal intra prediction mode from macroblocks in a regular unit, which are encoded prior to a current macroblock, the transform base generator generating transform bases for respective intra prediction modes based on the prediction errors collected by the intra prediction error collector. Accordingly, the intra prediction encoding performance can be significantly improved with adding no addition information by adaptively generating a transform base according to an image characteristic change and transform-encoding an intra prediction error. As a result, the compression efficiency of a video compression apparatus or the picture quality of a reconstructed image can be greatly improved.

### TECHNICAL FIELD

The present disclosure relates to an image-encoding apparatus and method, a transform-encoding apparatus and method, an apparatus and method for generating a transform base, and an image-decoding apparatus and method used in the same. More particularly, the present disclosure relates to a video encoding apparatus and method, which can significantly improve the intra prediction encoding performance with adding no additional information by adaptively generating a transform base according to an image characteristic change as well as an intra prediction mode for a specific encoding unit and transform-encoding an intra prediction error, and a transform encoding apparatus and method, a transform base generating apparatus and method, and a video decoding apparatus and method used in the same.

### BACKGROUND

The statements in this section merely provide background information related to the present disclosure and may not constitute the prior art.

As information and communication technologies including an internet are developed, the use of video communication is increased as well as voice communication. Conventional communication based on text is not sufficient to satisfy various demands of consumers. Accordingly, multimedia services capable of accommodating diverse types of information such as texts, videos, music, etc. are increasingly provided. Multimedia data requires a storage medium having a large capacity due to its large amount or size, and requires a wide bandwidth for a transmission. Therefore, it is necessary to use a compression coding technique to transmit the multimedia data including text, video, and audio data.

A basic principle of compressing a data includes a process of removing a factor of the data redundancy. The data can be compressed by removing the spatial redundancy corresponding to the repetition of the same color or object in an image, the temporal redundancy corresponding to the repetition of the same note in an audio or a case where there is little change of an adjacent frame in a dynamic image, or the psychological vision redundancy considering a fact that human's visual and perceptive abilities are insensitive to a high frequency.

As a video compressing method, H.264/AVC recently draws more interests for its improved compression efficiency over MPEG-4 (Moving Picture Experts Group-4).

Being a digital video codec standard with a very high data compression rate, H.264 is also referred to as MPEG-4 part 10 or AVC (Advanced Video Coding). This standard is a result from constructing a Joint Video Team and performing the standardization together by VCEG (Video Coding Experts Group) of ITU-T (International Telecommunication Union Telecommunication Standardization Sector) and MPEG of ISO/IEC (International Standardization Organization/International Electrotechnical Commission).

Various methods are proposed to improve the compression efficiency in a compression encoding, and include methods using a temporal prediction and a spatial prediction as representative methods.

The temporal prediction corresponds to a scheme of performing a prediction with reference to a reference block 122 of another frame 120 temporally adjacent in predicting a current block 112 of a current frame 110, as shown in FIG. 1. That is, in inter-predicting the current block 112 of the current frame 110, the temporally adjacent reference frame 120 is searched for, and the reference block 122, which is the most similar to the current block within the reference frame 120, is searched for. Here, the reference block 122 is a block, which can predict the current block 112 best, and a block, which has the smallest SAD (Sum of Absolute Difference) from the current block 112, can be the reference block 122. The reference block 122 becomes a predicted block of the current block 112, and a residual block is generated by subtracting the reference block 122 from the current block 112. The generated residual block is encoded and inserted in a bitstream. In this event, a relative difference between a position of the current block in the current frame 110 and a position of the reference block 122 in the reference frame 120 corresponds to a motion vector 130, and the motion vector 130 is encoded like the residual block. The temporal prediction is also referred to as an inter prediction or an inter frame prediction.

The spatial prediction corresponds to a prediction of obtaining a predicted pixel value of a target block by using a reconstructed pixel value of a reference block adjacent to the target block in one frame, and is also referred to as a directional intra prediction (hereinafter, simply referred to as an “intra prediction”) or an inter frame prediction. H.264 defines an encoding/decoding using the intra prediction.

The intra prediction corresponds to a scheme of predicting values of a current subblock by copying one subblock in a determined direction based on adjacent pixels located in an upper direction and a left direction with respect to the subblock and encoding only a differential. According to the intra prediction scheme based on the H.264 standard, a predicted block for a current block is generated based on another block having a prior coding order. Further, a coding is a value generated by subtracting the predicted block from the current block. A video encoder based on the H.264 standard selects a prediction mode having the smallest difference between the current block and the predicted block for each block from prediction modes.

The intra prediction based on the H.264 standard defines nine prediction modes shown in FIG. 2 in consideration of the prediction directivity and positions of adjacent pixels used for generating predicted pixel values of a 4×4 luma block and an 8×8 luma block. The nine prediction modes are divided into a vertical prediction mode (prediction mode 0), a horizontal prediction mode (prediction mode 1), a DC prediction mode (prediction mode 2), a diagonal_down_left prediction mode (prediction mode 3), a diagonal_down_right prediction mode (prediction mode 4), a vertical_right prediction mode (prediction mode 5), a horizontal_down prediction mode (prediction mode 6), a vertical_left prediction mode (prediction mode 7), and a horizontal_up prediction mode (prediction mode 8) according to their prediction directions. Here, the DC prediction mode uses an average value of eight adjacent pixels.

Further, four intra prediction modes are used for an intra prediction processing for a 16×16 luma block, wherein the four intra prediction modes are the vertical prediction mode (prediction mode 0), the horizontal prediction mode (prediction mode 1), the DC prediction mode (prediction mode 2), and the diagonal_down_left prediction mode (prediction mode 3). In addition, the same four intra prediction modes are used for an intra prediction processing for an 8×8 chroma block.

FIG. 3 illustrates a labeling example for the nine intra prediction modes shown in FIG. 2. In this event, a predicted block (an area including a to p) for the current block is generated using samples (A to M) decoded in advance. When E, F, G, and H cannot be decoded in advance, E, F, G, and H can be virtually generated by copying D in their positions.

FIG. 4 is a diagram for illustrating the nine prediction modes shown in FIG. 2 by using FIG. 3. Referring to FIG. 4, a predicted block in a case of the prediction mode 0 predicts pixel values in the same vertical line as the same pixel value. That is, in pixels of the predicted block, pixel values are predicted from pixels, which are most adjacent to a reference block located in an upper side of the predicted block. Reconstructed pixel values of an adjacent pixel A are set to predicted pixel values of a pixel a, a pixel e, a pixel i, and a pixel m in a first column of the predicted block. Further, in the same way, pixel values of a pixel b, a pixel f, a pixel j, and a pixel n in a second column are predicted from reconstructed pixel values of an adjacent pixel B, pixel values of a pixel c, a pixel g, a pixel k, and a pixel o in a third column are predicted from reconstructed pixel values of an adjacent pixel C, and pixel values of a pixel d, a pixel h, a pixel I, and a pixel p in a fourth column are predicted from reconstructed pixel values of an adjacent pixel D. As a result, a predicted block in which predicted pixel values of each column correspond to pixel values of the pixel A, pixel B, pixel C, and pixel D is generated as shown in FIG. 5A.

Further, a predicted block in a case of the prediction mode 1 predicts pixel values in the same horizontal line as the same pixel value. That is, in pixels of the predicted block, pixel values are predicted from pixels, which are most adjacent to a reference block located in a left side of the predicted block. Reconstructed pixel values of an adjacent pixel I are set to predicted pixel values of a pixel a, a pixel b, a pixel c, and a pixel d in a first row of the predicted block. Further, in the same way, pixel values of a pixel e, a pixel f, a pixel g, and a pixel h in a second row are predicted from reconstructed pixel values of an adjacent pixel J, pixel values of a pixel i, a pixel j, a pixel k, and a pixel I in a third row are predicted from reconstructed pixel values of an adjacent pixel K, and pixel values of a pixel m, a pixel n, a pixel o, and a pixel p in a fourth row are predicted from reconstructed pixel values of an adjacent pixel L. As a result, a predicted block in which predicted pixel values of each column correspond to pixel values of the pixel I, pixel J, pixel K, and pixel L is generated as shown in FIG. 5B.

Furthermore, pixels of a predicted block in a case of the prediction mode 2 are equally replaced with an average of pixel values of upper pixels A, B, C, and D, and left pixels I, J, K, and L.

Meanwhile, pixels of a predicted block in a case of the prediction mode 3 are interpolated in a lower-left direction at an angle of 45° between a lower-left side and an upper-right side of the predicted block, and pixels of a predicted block in a case of the prediction mode 4 are extrapolated in a lower-right direction at an angle of 45° between a lower-left side and an upper-right side of the predicted block. Further, pixels of a predicted block in a case of the prediction mode 5 are extrapolated in a lower-right direction at an angle of about 26.6° (width/height=1/2) with respect to a vertical line. In addition, pixels of a predicted block in a case of the prediction mode 6 are extrapolated in a lower-right direction at an angle of about 26.6° with respect to a horizontal line, pixels of a predicted block in a case of the prediction mode 7 are extrapolated in a lower-left direction at an angle of about 26.6° with respect to a vertical line, and pixels of a predicted block in a case of the prediction mode 8 are interpolated in an upper direction at an angle of about 26.6° with respect to a horizontal line.

The pixels of the predicted block can be generated from a weighted average of the pixels A to M of the reference block decoded in advance in the prediction mode 3 to 8. For example, in a case of the prediction mode 4, the pixel d located in an upper right side of the predicted block can be estimated as shown in Equation (1). Here, a round( ) function is a function of rounding off to the nearest whole number.

d=round(B/4+C/2+D/4) Equation 1

Meanwhile, in a 16×16 prediction model for luma components, there are 4 modes including the prediction mode 0, prediction mode 1, prediction mode 2, and prediction mode 3 as described above.

In a case of the prediction mode 0, pixels of the predicted block are interpolated from upper pixels, and, in a case of the prediction mode 1, the pixels of the predicted block are interpolated from left pixels. Further, in a case of the prediction mode 2, the pixels of the predicted block are calculated as an average of the upper pixels and the left pixels. Lastly, in a case of the prediction mode 3, a linear “plane” function suitable for the upper pixels and the left pixels is used. The prediction mode 3 is more suitable for an area in which the luminance is smoothly changed.

As described above, in the H.264 standard, pixel values of the predicted block are generated in directions corresponding to respective modes based on adjacent pixels of the predicted block to be currently encoded in the respective prediction modes except for the DC mode.

Meanwhile, a prediction error between a predicted value predicted by each prediction mode and a current pixel value is transform-encoded using an integer transform scheme based on a DCT (Discrete Cosine Transform). An integer transform in the 4×4 unit is applied when a 4×4 intra prediction mode and a 16×16 intra prediction mode are used according to a block size, and an inter transform in the 8×8 unit is applied when an 8×8 intra prediction mode is used.

The Video Coding Expert Group of the ITU-T has further developed the H.264 standard recently, so that the predictive encoding performance is further improved. Specifically, the predictive encoding performance is improved by increasing the number of intra prediction modes through further diversifying the directivity of a pixel value used in the intra prediction and introducing a scheme of adding weights of two intra prediction modes in “Improvement of Bidirectional Intra Prediction”, ITU-T SG16/Q.6 Doc. VCEG-AG08, October 2007 by Shiodera Taichiro, Akiyuki Tanizawa, Takeshi Chujoh, and Tomoo Yamakage. However, this scheme has a disadvantage of greatly increasing an amount of operations for finding an optimal mode according to the increase of the number of intra prediction modes, which should be considered, up to 4 times and thus increasing an amount of additional information for encoding the increased prediction modes.

Unlike a conventional research for improving the intra mode encoding through performing an exact intra encoding, a transform scheme of using different KLT (Karhunen-Loeve Transform) based directivity bases is proposed based on the idea that there still remains the spatial redundancy in a prediction error after the intra prediction and such a spatial redundancy has a high correlation with an intra prediction direction in “Improved Intra Coding”, ITU-T SG16/Q.6 Doc. VCEG-AG11, October 2007 by Yan Ye and Marta Karczewicz. The transform scheme has significantly improved the intra mode encoding performance by performing an adaptive prediction error encoding according to the intra prediction mode without any addition information by using KLT transform bases trained through several experiment images. However, the transform scheme has a disadvantage that a generated transform base cannot have the optimal energy concentration efficiency for various video sequences having different characteristics or other partial local images having different characteristics within one sequence.

### DISCLOSURE

### Technical Problem

An aspect of the present disclosure to solve the above-mentioned problem provides a higher energy concentration effect by efficiently removing the spatial redundancy remaining in a prediction error, and provides a video encoding apparatus and method, which can improve the compression efficiency of an intra prediction encoding by adaptively generating a transform base according to a local characteristic change of the prediction error as well as an intra prediction mode and using the generated transform base in a transform encoding of the prediction error in order to more efficiently transform-encode the prediction error after an intra prediction, and a transform encoding apparatus and method, a transform base generating apparatus and method, and a video decoding apparatus and method used in the same.

### SUMMARY

An aspect of the present disclosure provides a video encoding apparatus, including: an intra prediction error collector for collecting prediction errors of blocks having an equal intra prediction mode from macroblocks in a regular unit, which are encoded prior to a current macroblock; a transform base generator for generating transform bases for respective intra prediction modes based on the prediction errors collected by the intra prediction error collector; an intra predictor for predicting a pixel value of a current pixel by using neighboring pixels of a target block within a current frame according to a directional intra prediction mode and generating a prediction error through a difference between a predicted pixel value and the current pixel; and a transform encoder for transform-encoding the prediction error generated by the intra predictor by using the transform bases generated by the transform base generator.

Preferably, the transform base generator includes a correlation matrix calculator for calculating an autocorrelation matrix for a set of the prediction errors collected by the intra prediction error collector. In this event, the transform base generator generates a Karhunen-Loeve Transform or KLT-based transform base based on the autocorrelation matrix calculated by the correlation matrix calculator.

The transform base generator may include a correlation matrix calculator for calculating an autocorrelation matrix for a set of the prediction errors collected by the intra prediction error collector; and an eigenvector calculator for calculating an eigenvector from the autocorrelation matrix calculated by the correlation matrix calculator. In this event, the transform encoder preferably transform-encodes the prediction error generated by the intra predictor by using a calculated eigenvector.

Another aspect of the present disclosure provides a transform encoding apparatus for transforming and encoding a prediction error generated by a difference between a predicted pixel predicted by an intra prediction apparatus and a current pixel, the transform encoding apparatus including: an intra prediction error collector for collecting prediction errors of blocks having an equal intra prediction mode from macroblocks in a regular unit, which are encoded prior to a current macroblock; and a transform base generator for generating transform bases for respective intra prediction modes based on the prediction errors collected by the intra prediction error collector. In this event, the transform encoding apparatus preferably transform-encoding the prediction error generated by the intra prediction apparatus by using the transform bases generated by the transform base generator.

Preferably, the intra prediction error collector may collect the prediction errors into a set as defined in an equation of P^{m}={Pₖ^{m}|1≦k≦Nₘ}, where m denotes an index indicating a 4×4 intra prediction mode number, the index having values from 0 to 8, Nₘ denotes a number of blocks in which an intra prediction mode is determined as an intra prediction mode m among macroblocks in a regular unit which are encoded prior to a current macroblock, P^{m} denotes a 4×4 prediction error block set of the blocks in which the intra prediction mode is determined as the intra prediction mode m| among the macroblocks in the regular unit which are encoded prior to the current macroblock, and Pₖ^{m} denotes one 4×4 prediction error block which is a k^{th} element of P^{m}.

The transform encoding apparatus may further include a correlation matrix calculator for calculating an autocorrelation matrix for a set of the prediction errors collected by the intra prediction error collector based on an equation of

$${R}_{c}^{m} = E [ {{P}_{k}^{m} ( {P}_{k}^{m} )}^{T} ] = \frac{1}{{N}_{m}} {\sum }_{k = 1}^{{N}_{m}} {{P}_{k}^{m} ( {P}_{k}^{m} )}^{T} ,$$

where R_{c}^{m} denotes a 4×4 autocorrelation matrix for a column vector signal of a 4×4 intra prediction error in which an intra prediction mode is determined as an intra prediction mode m, m denotes an index indicating a 4×4 intra prediction mode number, the index having values from 0 to 8, Nₘ denotes a number of blocks in which an prediction mode is determined as the intra prediction mode m| among macroblocks in a regular unit which are encoded prior to a current macroblock, and Pₖ^{m} denotes one 4×4 prediction error block which is a k^{th} element of P^{m} denoting a 4×4 prediction error block set of the blocks in which the intra prediction mode is determined as the intra prediction mode m| among the macroblocks in the regular unit which are encoded prior to the current macroblock, wherein the transform base generator generates transform bases by using a calculated autocorrelation matrix.

The transform encoding apparatus may further include a correlation matrix calculator for calculating an autocorrelation matrix for a set of the prediction errors collected by the intra prediction error collector based on an equation of

$${R}_{r}^{m} = E [ {( {P}_{k}^{m} )}^{T} {P}_{k}^{m} ] = \frac{1}{{N}_{m}} {\sum }_{k = 1}^{{N}_{m}} {( {P}_{k}^{m} )}^{T} {P}_{k}^{m} ,$$

where Rᵣ^{m} denotes a 4×4 autocorrelation matrix for a row vector signal of a 4×4 intra prediction error in which an intra prediction mode is determined as an intra prediction mode m|, m| denotes an index indicating a 4×4 intra prediction mode number, the index having values from 0 to 8, Nₘ denotes a number of blocks in which an intra prediction mode is determined as the intra prediction mode m| among macroblocks in a regular unit which are encoded prior to a current macroblock, and Pₖ^{m} denotes one 4×4 prediction error block which is a k^{th} element of P^{m} denoting a 4×4 prediction error block set of the blocks in which the intra prediction mode is determined as the intra prediction mode m| among the macroblocks in the regular unit which are encoded prior to the current macroblock, wherein the transform base generator generates transform bases by using a calculated autocorrelation matrix.

Yet another aspect of the present disclosure provides a transform base generating apparatus for generating transform bases for intra prediction modes, the transform base generating apparatus including: an intra prediction error collector for collecting prediction errors of blocks having an equal intra prediction mode from macroblocks in a regular unit, which are encoded prior to a current macroblock; a correlation matrix calculator for calculating an autocorrelation matrix for a set of the prediction errors collected by the intra prediction error collector; and an eigenvector calculator for calculating an eigenvector from the autocorrelation matrix calculated by the correlation matrix calculator, the transform base generating apparatus generating the transform base for each intra prediction mode based on the eigenvector calculated by the eigenvector calculator.

Here, the transform base generating apparatus preferably generates a KLT-based transform base based on the autocorrelation matrix and the eigenvector.

Yet another aspect of the present disclosure provides an intra prediction apparatus, including: an intra predictor for predicting a pixel value of a current pixel by using neighboring pixels of a target block within a current frame according to a directional intra prediction mode and generating a prediction error through a difference between a predicted pixel value and the current pixel; and an intra prediction error collector for collecting prediction errors of blocks having an equal intra prediction mode from macroblocks in a regular unit, which are encoded prior to a current macroblock. In this event, the intra prediction apparatus preferably outputs the prediction errors for the macroblocks in the regular unit, which are encoded prior to the current macroblock, the prediction error being collected by the intra prediction error collector, together with the prediction error generated by the intra predictor for the current frame.

Yet another aspect of the present disclosure provides a video decoding apparatus, including: an intra prediction error collector for collecting prediction errors of blocks having an equal intra prediction mode from macroblocks in a regular unit, which are encoded prior to a current macroblock; a transform base generator for generating transform bases for respective intra prediction modes based on the prediction errors collected by the intra prediction error collector; an intra prediction mode reader for reading an intra prediction mode of a target block to be decoded for an input bitstream; an inverse transformer for inversely transforming a prediction error for the target block by using a transform base corresponding to the intra prediction mode read by the intra prediction mode reader among the transform bases generated by the transform base generator; and a current block reconstructer for predicting a pixel value of a current pixel by using neighboring pixels of the target block within a current frame according to the intra prediction mode read by the intra prediction mode reader and reconstructing a current block by adding a predicted pixel value and a value of the prediction error inversely transformed by the inverse transformer.

Here, the transform base generator preferably includes a correlation matrix calculator for calculating an autocorrelation matrix for a set of the prediction errors collected by the intra prediction error collector; and an eigenvector calculator for calculating an eigenvector from the autocorrelation matrix calculated by the correlation matrix calculator, and generates a KLT-based transform base based on the autocorrelation matrix and the eigenvector.

Yet another aspect of the present disclosure provides a video encoding method, including: collecting prediction errors of blocks having an equal intra prediction mode from macroblocks in a regular unit, which are encoded prior to a current macroblock, and predicting a value of a current pixel by using neighboring pixels of a target block according to a directional intra prediction mode for a current frame and generating a prediction error through a difference between a predicted value and the value of the current pixel; generating transform bases for respective intra prediction modes based on the prediction errors collected in collecting of the prediction errors; and transform-encoding the prediction error generated for the current frame by using the transform bases generated in generating of the transform bases.

Another aspect of the present disclosure provides a transform encoding method of transforming and encoding a prediction error generated by a difference between a pixel predicted by an intra prediction apparatus and a current pixel, the transform encoding method including: collecting prediction errors of blocks having an equal intra prediction mode from macroblocks in a regular unit, which are encoded prior to a current macroblock; generating transform bases for respective intra prediction modes based on the prediction errors collected in collecting of the prediction errors. In this event, the transform encoding method preferably transform-encodes the prediction error generated by the intra prediction apparatus by using the transform bases generated in generating of the transform bases.

The transform encoding method preferably further includes calculating an autocorrelation matrix for a set of the prediction errors collected in collecting of the prediction errors. In this event, the process of generating the transform bases generates the transform bases by using a calculated autocorrelation matrix.

Yet another aspect of the present disclosure provides a video decoding method, including: collecting prediction errors of blocks having an equal intra prediction mode from macroblocks in a regular unit, which are encoded prior to a current macroblock; generating transform bases for respective intra prediction modes based on the prediction errors collected in collecting of the prediction errors; reading an intra prediction mode of a target block to be decoded for an input bitstream; inversely transforming a prediction error for the target block by using a transform base corresponding to the intra prediction mode read in reading of the intra prediction mode among the transform bases generated in generating of the transform bases; and predicting a pixel value of a current pixel by using neighboring pixels of the target block within a current frame according to the intra prediction mode read in reading of the intra prediction mode and reconstructing a current block by adding a predicted pixel value and a value of the prediction error inversely transformed in inversely transforming of the prediction error.

The process of generating the transform bases preferably includes calculating an autocorrelation matrix for a set of the prediction errors collected in collecting of the prediction errors; and calculating an eigenvector from the autocorrelation matrix calculated in calculating of the correlation matrix. In this event, a KLT-based transform base is preferably generated based on the autocorrelation matrix and the eigenvector.

### Advantageous Effects

According to the present disclosure as described above, the intra predictive encoding performance can be significantly improved with adding no additional information by adaptively generating a transform base according to an image characteristic change as well as an intra prediction mode for the specific encoding unit and transform-encoding an intra prediction error, and thus the compression efficiency of a compression apparatus or the picture quality of a reconstructed image can be greatly improved.

### DESCRIPTION OF DRAWINGS

FIG. 1 is a diagram for illustrating a general inter prediction;

FIG. 2 is a diagram for illustrating the directivity of intra prediction modes;

FIG. 3 is a diagram illustrating a labeling example for the intra prediction modes of FIG. 2;

FIG. 4 is a diagram for illustrating respective intra prediction modes of FIG. 2;

FIG. 5A is a diagram for illustrating a prediction mode 0 among the intra prediction modes of FIG. 2, and FIG. 5B is a diagram for illustrating a prediction mode 1 among the intra prediction modes of FIG. 2;

FIG. 6 is a diagram schematically illustrating a video encoding apparatus according to an aspect of the present disclosure;

FIG. 7 is a flowchart illustrating a video encoding method by the video encoding apparatus of FIG. 6;

FIG. 8 is a flowchart illustrating a transform encoding method according to another aspect of the present disclosure;

FIG. 9 is a diagram illustrating an example of a structure of a bitstream generated by the video encoding apparatus of FIG. 6;

FIG. 10 is a diagram schematically illustrating a video decoding apparatus according to an aspect of the present disclosure; and

FIG. 11 is a flowchart illustrating the video decoding method by the video decoding apparatus of FIG. 10.

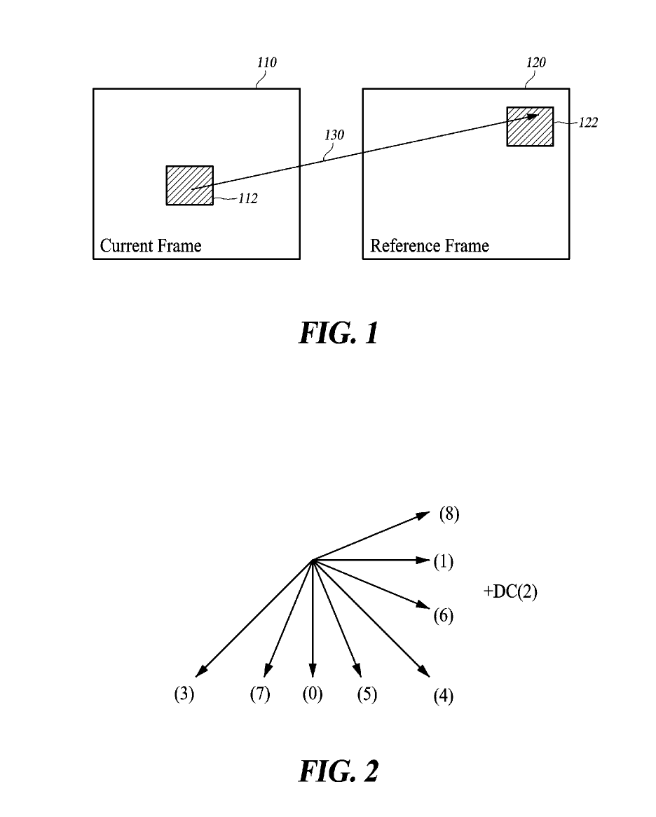

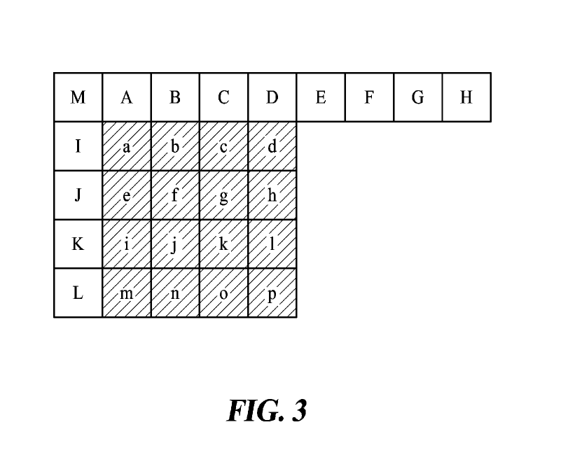

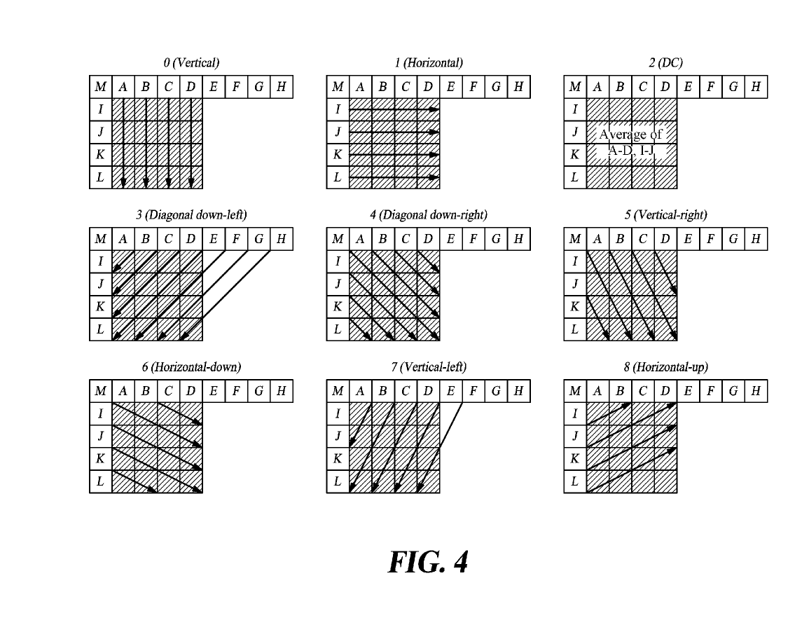

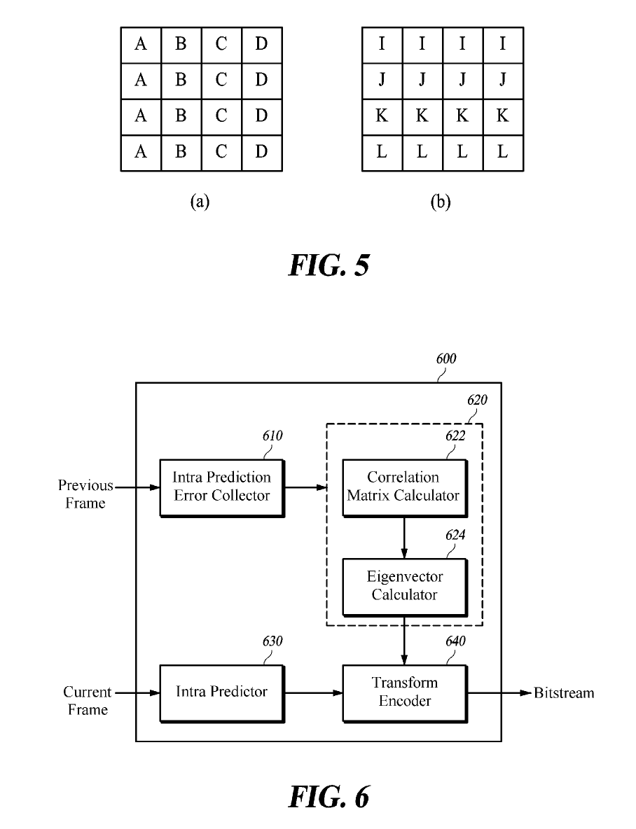

### DETAILED DESCRIPTION

Hereinafter, aspects of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

FIG. 6 is a diagram schematically illustrating a video encoding apparatus according to an aspect of the present disclosure. Referring to FIG. 6, the video encoding apparatus 600 includes an intra prediction error collector 610, a transform base generator 620, an intra predictor 630, and a transform encoder 640. Here, the intra prediction error collector 610, the transform base generator 620, and the transform encoder 640 may be referred to as a transform encoding apparatus.

The intra prediction error collector 610 collects prediction errors of blocks having the same intra prediction mode from macroblocks in the regular unit, which are encoded prior to a current macroblock. That is, in order to generate transform bases for various intra prediction modes, the intra prediction error collector 610 receives macroblocks in the regular unit, which are encoded prior to the current macroblock, and collects prediction errors of blocks having the same intra prediction mode from blocks in which intra prediction modes have been determined. In this event, since 9 types of intra prediction modes are defined in the 4×4 intra prediction mode and the 8×8 intra prediction mode, 4×4 intra prediction errors and 8×8 intra mode prediction errors can be collected into 9 types, respectively. Further, since 4 types of intra prediction modes are defined in the 16×16 intra prediction mode, 16×16 intra prediction errors can be collected into 4 types. For example, intra prediction errors for the 4×4 intra prediction mode can be collected into a set as defined in Equation (2).

P^{m}={Pₖ^{m}|1≦k≦Nₘ}| Equation 2

In Equation (2), m| denotes an index indicating a number of the 4×4 intra prediction mode, wherein the index has values from 0 to 8. Nₘ denotes the number of blocks in which an intra prediction mode is determined as an intra prediction mode m| among macroblocks in the regular unit which are encoded prior to the current macroblock. Further, P^{m} denotes a 4×4 prediction error block set of the blocks in which the intra prediction mode is determined as the intra prediction mode m among the macroblocks in the regular unit which are encoded prior to the current macroblock, and Pₖ^{m} one 4×4 prediction error block which is a k^{th} element of P^{m}.

The transform base generator 620 generates transform bases of respective intra prediction modes based on prediction errors collected by the intra prediction error collector 610 according to an intra prediction block size and an intra prediction mode. Here, it is preferable that the transform base is generated based on a Karhunen-Loeve Transform or KLT, which is theoretically known as a transform having the best energy concentration efficiency. The transform base generator 620 can be implemented as an independent element, or may include a correlation matrix calculator 622 and an eigenvector calculator 624. Further, the transform base generating apparatus can be implemented, including the intra prediction error collector 610, the correlation matrix calculator 622, and the eigenvector calculator 624.

The correlation matrix calculator 622 calculates an autocorrelation matrix for a set of the prediction errors collected by the intra prediction error collector 610. In the case of the 4×4 intra prediction mode, two transform bases for a column vector signal and a row vector signal should be generated in Equation (2) because the intra prediction error block Pₖ^{m} is a two-dimensional signal. Further, an autocorrelation matrix of the intra prediction error should be obtained in order to generate the KLT base, and the autocorrelation matrix can be obtained as defined in Equations (3) and (4).

$$\begin{matrix}{R}_{c}^{m} = E [ {{P}_{k}^{m} ( {P}_{k}^{m} )}^{T} ] = \frac{1}{{N}_{m}} {\sum }_{k = 1}^{{N}_{m}} {{P}_{k}^{m} ( {P}_{k}^{m} )}^{T} & Equation 3 \\ {R}_{r}^{m} = E [ {( {P}_{k}^{m} )}^{T} {P}_{k}^{m} ] = \frac{1}{{N}_{m}} {\sum }_{k = 1}^{{N}_{m}} {( {P}_{k}^{m} )}^{T} {P}_{k}^{m} & Equation 4\end{matrix}$$

In Equation (3), R_{c}^{m} denotes a 4×4 autocorrelation matrix for a column vector signal of a 4×4 intra prediction error in which an intra prediction mode is determined as an intra prediction mode m|, and m| denotes an index indicating a number of the 4×4 intra prediction mode, wherein the index has values from 0 to 8. Further, Nₘ denotes the number of blocks in which an intra prediction mode is determined as the intra prediction mode m among macroblocks in the regular unit which are encoded prior to the current macroblock, and Pₖ^{m} denotes one 4×4 prediction error block which is a k^{th} element of P^{m} denoting a 4×4 prediction error block set of the blocks in which the intra prediction mode is determined as the intra prediction mode m among the macroblocks in the regular unit which are encoded prior to the current macroblock. Further, Rᵣ^{m} denotes a 4×4 autocorrelation matrix for a row vector signal of the 4×4 intra prediction error in which the intra prediction mode is determined as the intra prediction mode m.

The KLT base for the 4×4 intra prediction error block can be obtained through an eigenvector of the autocorrelation matrix, and the eigenvector calculator 624 can calculate eigenvectors as defined in Equations (5) and (6) from the autocorrelation matrices defined in Equations (3) and (4), which are calculated by the correlation matrix calculator 622.

R_{c}^{m}φₙ^{m,c}=λₙ^{m,c}φₙ^{m,c}, 0≦n≦3 Equation 5

Rᵣ^{m}φₙ^{m,r}=λₙ^{m,r}φₙ^{m,r}, 0≦n≦3 Equation 6

In Equation (5), φₙ^{m,c} denotes an eigenvector of R_{c}^{m}, λₙ^{m,c} denotes an eigenvalue of R_{c}^{m}. Further, in Equation (6), φₙ^{m,r} denotes an eigenvector of Rᵣ^{m}, and λₙ^{m,r}, denotes an eigenvalue of Rᵣ^{m}. Equations (7) and (8) can be generated by obtaining eigenvectors satisfying Equations (5) and (6) and expressing the eigenvectors as matrices.

Φ_{c}^{m}=└φ₀^{m,c} φ₁^{m,c} φ₂^{m,c} φ₃^{m,c}┘| Equation 7

Φᵣ^{m}=└φ₀^{m,r} φ₁^{m,r} φ₂^{m,r} φ₃^{m,r}┘| Equation 8

In Equation (7), Φ_{c}^{m} denotes a KLT base for a column vector signal of a prediction error block corresponding to the intra prediction mode m|, and, in Equation (8), φᵣ^{m} denotes a KLT base for a row vector signal of the prediction error block corresponding to the intra prediction mode m.

Meanwhile, the intra predictor 630 predicts a pixel value for a predicted block by using neighboring pixels of a target block within a current frame according to a directional intra prediction mode. Further, the intra predictor 630 generates a prediction error through a difference between the pixel value for the target block and the pixel value for the predicted block. That is, the intra predictor 630 includes a differentiator (not shown) for calculating a differential between the target block and the predicted block.

The transform encoder 640 transform-encodes a prediction error generated by the intra predictor 630 by using transform bases generated by the transform base generator 620. The aforementioned transform of the two-dimensional signal using the KLT base is performed as defined in Equation (9).

V^{m}=(Φ_{c}^{m})^{T}U^{m}(Φᵣ^{m})| Equation 9

In Equation (9), U^{m} denotes a prediction error signal of the intra prediction mode m|, and V^{m} denotes a signal transformed by a KLT of U^{m}.

Although a case of the 4×4 intra prediction mode has been described as an example, a method of generating a KLT base for an intra prediction error of the 8×8 intra prediction mode is equal to the case of the 4×4 intra prediction mode. Further, a method of generating a KLT base for an intra prediction error of the 16×16 intra prediction mode is equal to the case of the 4×4 intra prediction mode, and only difference is that the number of intra prediction error sets and the number of KLT bases are 4 smaller than those of the 4×4 intra prediction mode.

The KLT base generated by the transform base generator 620 is not a transform base optimized for the prediction error generated by the intra predictor 630, but the KLT base has no significant difference in performance from a transform base optimized for a current frame because there is a high correlation between the current frame and a previous frame based on characteristics of a general video signal, and has properties, which require the transmission of no additional information on a transform base for a decoding by generating the transform base among macroblocks in the regular unit, which are encoded prior to the current macroblock.

Meanwhile, although it has been described that the intra predictor 630 is independently constructed from the intra prediction error collector 610 in FIG. 6, the intra predictor 630 may include the intra prediction error collector 610. That is, the intra predictor 630 predicts the pixel value of the predicted block by using neighboring pixels of the target block within the current frame according to the directional intra prediction mode, generates the prediction error through the difference between the pixel value of the predicted block and the pixel value of the target block, and collects prediction errors of blocks having the same intra prediction mode from blocks in which intra prediction modes have been determined among macroblocks in the regular unit, which are encoded prior to the current macroblock at the same time, so that the intra prediction can output a prediction error of the current frame together with the collected prediction errors of the blocks.

When an intra prediction encoding is performed according to the aforementioned method, not only the performance can be improved by applying different transform bases depending on intra perdition modes but more excellent intra prediction encoding efficiency can be achieved by providing an adaptive transform base, which can immediately respond to a characteristic change of an image, in every specific encoding unit.

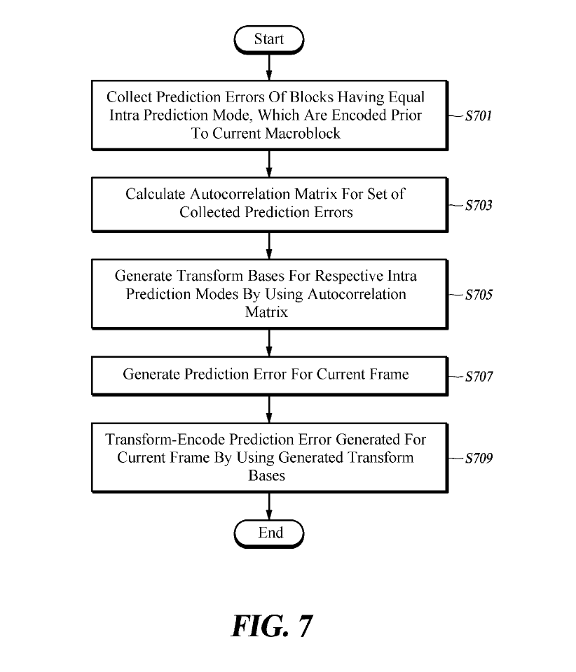

FIG. 7 is a flowchart illustrating a video encoding method by the video encoding apparatus of FIG. 6.

Referring to FIG. 7, the intra prediction error collector 610 collects prediction errors of blocks having the same intra prediction mode from macroblocks in the regular unit, which are encoded prior to a current macroblock in step S701. The collected prediction errors for the macroblocks in the regular unit, which are encoded prior to the current macroblock, can be expressed in a form of a set as shown in FIG. 2.

The transform base generator 620 calculates an autocorrelation matrix for an intra prediction mode set based on the prediction errors collected by the intra prediction error collector 610 in step S703. In this event, since the 4×4 intra prediction error block Pₖ^{m} is a two-dimensional signal, two types of transform bases for a column vector signal and a row vector signal should be generated. Further, in order to generate the KLT base, the autocorrelation matrix can be calculated as defined in Equations (3) and (4). In this event, the KLT base can be calculated through an eigenvector of the autocorrelation matrix as defined in Equations (5) and (6) in step S705. The calculated eigenvector can be expressed as matrices shown in Equations (7) and (8).

Meanwhile, the intra predictor 630 predicts a pixel value of a current pixel by using neighboring pixels of a target block within a current frame according to a directional intra prediction mode, and generates a prediction error through a difference between the predicted pixel and the current pixel in step S707.

The transform encoder 640 transform-encodes the prediction error generated by the intra predictor 630 by using the transform bases generated by the transform base generator 620 as shown in Equation (9).

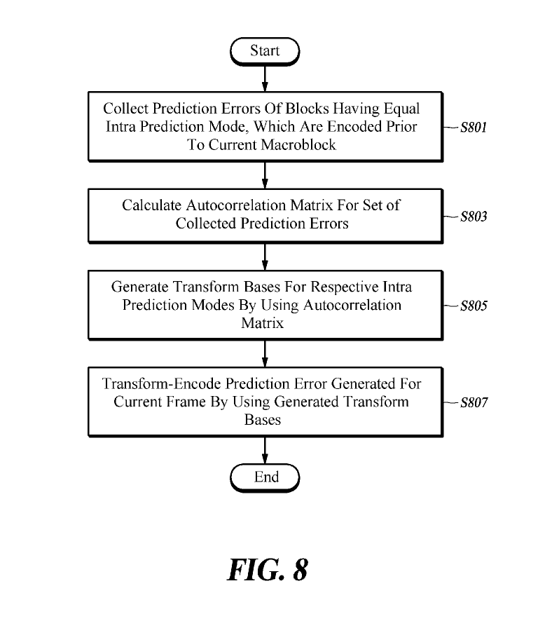

FIG. 8 is a flowchart illustrating a transform encoding method according to another aspect of the present disclosure. When the intra predictor 630 is independently constructed from the intra prediction error collector 610, the transform base generator 620, and the transform encoder 640, the intra prediction error collector 610, the transform base generator 620, and the transform encoder 640 may be referred to as elements of the transform encoding apparatus. In this event, steps S801 to S805 of the transform encoding apparatus are equally performed to steps S701 to S705 of FIG. 7, and the prediction error independently generated using the generated transform base by the intra predictor 630 is transform-encoded in step S807.

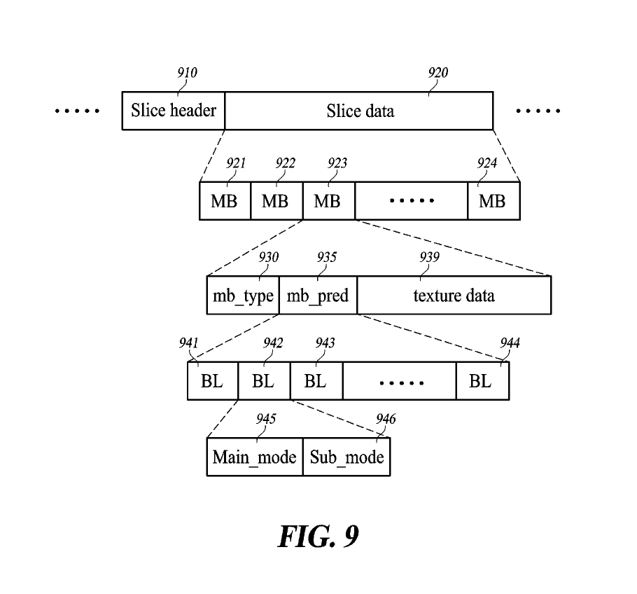

FIG. 9 is a diagram illustrating an example of a structure of a bitstream generated by the video encoding apparatus of FIG. 6. In the H.264 standard, the bitstream is encoded in the unit of slices. The bitstream includes a slice header 910 and a slice data 920, and the slice data 920 includes a plurality of macroblock data (MB) 921 to 924. Further, one macroblock data 923 may include an mb_type field 930, an mb_pred field 935, and a texture data field 939.

Here, the mb_type field 930 records a value indicating a macroblock type. That is, the value recorded in the mb_type field 930 indicates whether a current macroblock is an intra macroblock or an inter macroblock.

Further, the mb_pred field 935 records a detailed prediction mode according to the macroblock type. In a case of the intra macroblock, an information on a prediction mode selected in the intra prediction is recorded. In a case of the inter macroblock, an information on a motion vector and a reference frame number for each macroblock partition is recorded.

When the mb_type field 930 indicates the intra macroblock, the mb_pred field 935 is divided into a plurality of block information 941 to 944, and each information piece 942 is divided into a main_mode field 945 for recording a value of a main mode and a sub_mode field 946 for recording a value of a sub mode.

Lastly, the texture data field 939 records an encoded residual image, that is, a texture data.

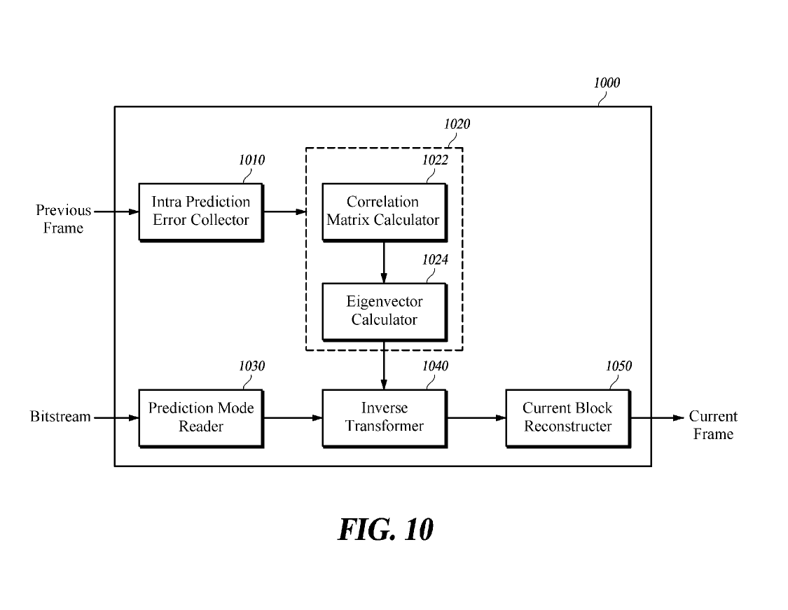

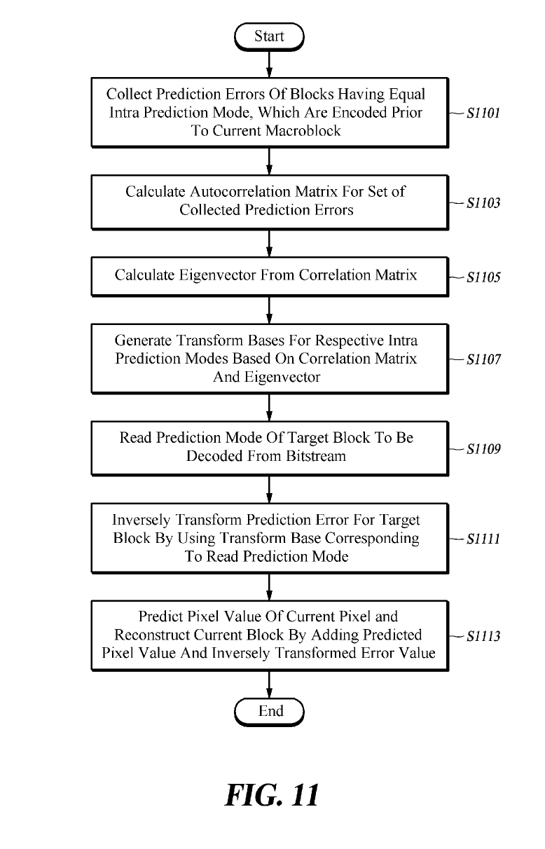

FIG. 10 is a diagram schematically illustrating a video decoding apparatus according to an aspect of the present disclosure, and FIG. 11 is a flowchart illustrating the video decoding method by the video decoding apparatus of FIG. 10. A detailed construction and operation of the video decoding apparatus 1000 will be described with reference to FIGS. 10 and 11.

Referring to FIGS. 10 and 11, the video decoding apparatus 1000 includes an intra prediction error collector 1010, a transform base generator 1020, a prediction mode reader 1030, an inverse transformer 1040, and a current block reconstructer 1050. Here, the transform base generator 1020 may include a correlation matrix calculator 1022 and an eigenvector calculator 1024.

The intra prediction error collector 1010 collects prediction errors of blocks having the same intra prediction mode from macroblocks in the regular unit, which are encoded prior to a current macroblock in step S1101. That is, in order to generate transform bases for various intra prediction modes, the intra prediction error collector 1010 receives the macroblocks in the regular unit, which are encoded prior to the current macroblock, and collects the prediction errors of the blocks having the same intra prediction mode from blocks in which intra prediction modes have been selected, like the intra prediction error collector of FIG. 6. In this event, since 9 types of intra prediction modes are defined in the 4×4 intra prediction mode and the 8×8 intra prediction mode, 4×4 intra prediction errors and 8×8 intra mode prediction errors can be collected into 9 types, respectively. Further, since 4 types of intra prediction modes are defined in the 16×16 intra prediction mode, 16×16 intra prediction errors can be collected into 4 types. For example, intra prediction errors for the 4×4 intra prediction mode can be collected into a set as defined in Equation (2).

The transform base generator 1020 generates transform bases for respective intra prediction modes based on the prediction errors collected by the intra prediction error collector 1010. Here, it is preferable that the transform base is generated based on the KLT, which is theoretically known as a transform having the best energy concentration efficiency like a case of the video encoding apparatus 600. The transform base generator 1020 can be implemented as an independent element, or implemented as the transform base generating apparatus including the intra prediction error collector 1010, the correlation matrix calculator 1022, and the eigenvector calculator 1024.

The correlation matrix calculator 1022 calculates an autocorrelation matrix for a set of the prediction errors collected by the intra prediction error collector 1010 in step S1103. In the case of the 4×4 intra prediction mode, two transform bases for a column vector signal and a row vector signal should be generated in Equation (2) because the intra prediction error block is a two-dimensional signal. Further, an autocorrelation matrix of the intra prediction error should be obtained in order to generate the KLT base, and the autocorrelation matrix can be obtained as defined in Equations (3) and (4).

Further, the KLT base for the 4×4 intra prediction error block can be obtained through an eigenvector of the autocorrelation matrix, and the eigenvector calculator 1024 can calculate eigenvectors as defined in Equations (5) and (6) from the autocorrelation matrices defined in Equations (3) and (4), which are calculated by the correlation matrix calculator 1022 in step S1105. In this event, the transform base generator 1020 can generate a KLT based transform base by obtaining eigenvectors satisfying Equations (5) and (6) and expressing the eigenvectors as matrices as defined in Equations (7) and (8).

The prediction mode reader 1030 reads an intra prediction mode of a target block to be decoded from the bitstream structure shown in FIG. 9 in step S1109. That is, the prediction mode reader 1030 receives a bitstream generated in the video encoding apparatus 600 and reads the intra prediction mode of the target block to be decoded of the current frame.

The inverse transformer 1040 inversely transforms a prediction error received through the bitstream by using a transform base corresponding to the intra prediction mode read by the intra prediction mode reader 1030 among transform bases generated by the transform base generator 1020 in step S1111.

The prediction error of the target block received through the bitstream generated by the video encoding apparatus 600 is transform-encoded using different transform bases depending on the intra prediction mode of the target block unlike the H.264 standard applying the integer transform and the inverse transform based on a fixed DCT (Discrete Cosine Transform) in a process of the transform and inverse transform of the prediction error regardless of the intra prediction mode. Accordingly, the intra prediction mode reader 1030 determines the intra prediction mode of the target block to be decoded of the current frame from an input bitstream, and inversely transforms the prediction error by applying a transform base corresponding to the intra prediction mode read by the intra prediction mode reader 1030. In this event, an inverse transform of the two-dimensional signal using the aforementioned KLT based transform base can be performed as defined in Equation (10).

\hat{U}^{m}=((Φ_{c}^{m})^{T})⁻¹V^{m}(Φᵣ^{m})⁻¹ Equation 10

In Equation (10), V^{m} denotes a signal generated by transform-encoding a prediction error of the intra prediction mode m|, and Û^{m} denotes a signal generated by inversely transforming V^{m} by the KLT. In general, although an inverse matrix of the KLT base should be used in the inverse transform, a transpose matrix is used in the inverse transform without acquiring the inverse matrix because the KLT base is an orthogonal matrix generated through an eigenvector and thus the inverse matrix of the KLT base and the transpose matrix of the KLT base are equal to each other. Accordingly, the inverse transform of the two-dimensional signal can be performed as defined in Equation (11) by more simply using the transpose matrix instead of the inverse matrix.

Û^{m}=(Φ_{c}^{m})V^{m}(Φᵣ^{m})^{T}| Equation 11

The current block reconstructer 1050 predicts a pixel value of a current pixel by using neighboring pixels of a target block within a current frame according to the intra prediction mode read by the intra prediction mode reader 1030, and reconstructs a current block by adding the predicted pixel value and the prediction error value inversely transformed by the inverse transformer 1040 in step S1113.

Through the video encoding and decoding performed in the above described way, the inverse transform and decoding can be performed by generating exactly the same adaptive transform base with reference to a previous frame in which a decoding is terminated in the video decoding apparatus 1000 like the transform encoding performed by generating different adaptive transform bases depending on the intra prediction mode with reference to the previous frame in the video encoding apparatus 600.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

### INDUSTRIAL APPLICABILITY

As described above, the present disclosure is highly useful for application in the fields of an encoder and a decoder using an intra prediction, an image compression apparatus, etc. to generate an effect of improving the compression efficiency of an intra prediction encoding by adaptively generating a transform base according to a local characteristic change of a prediction error as well as an intra prediction mode and using the generated transform base in a transform encoding of the prediction error in order to efficiently transform-encoding the prediction error after the intra prediction.

### CROSS-REFERENCE TO RELATED APPLICATION

If applicable, this application claims priority under 35 U.S.C §119(a) of Patent Application No. 10-2009-0121980, filed on Dec. 9, 2009 in Korea, the entire content of which is incorporated herein by reference. In addition, this non-provisional application claims priority in countries, other than the U.S., with the same reason based on the Korean Patent Application, the entire content of which is hereby incorporated by reference.

1. A video encoding apparatus, comprising:
an intra prediction error collector for collecting prediction errors of blocks having an equal intra prediction mode from macroblocks in a regular unit, which are encoded prior to a current macroblock;
a transform base generator for generating transform bases for respective intra prediction modes based on the prediction errors collected by the intra prediction error collector;
an intra predictor for predicting a pixel value of a current pixel by using neighboring pixels of a target block within a current frame according to a directional intra prediction mode and generating a prediction error through a difference between a predicted pixel value and the current pixel; and
a transform encoder for transform-encoding the prediction error generated by the intra predictor by using the transform bases generated by the transform base generator.

2. The video encoding apparatus of claim 1, wherein the transform base generator comprises a correlation matrix calculator for calculating an autocorrelation matrix for a set of the prediction errors collected by the intra prediction error collector, and generates a Karhunen-Loeve Transform or KLT-based transform base based on the autocorrelation matrix calculated by the correlation matrix calculator.

3. The video encoding apparatus of claim 1, wherein the transform base generator comprises:
a correlation matrix calculator for calculating an autocorrelation matrix for a set of the prediction errors collected by the intra prediction error collector; and
an eigenvector calculator for calculating an eigenvector from the autocorrelation matrix calculated by the correlation matrix calculator,
wherein the transform encoder transform-encodes the prediction error generated by the intra predictor by using a calculated eigenvector.

4. A transform encoding apparatus for transforming and encoding a prediction error generated by a difference between a predicted pixel predicted by an intra prediction apparatus and a current pixel, the transform encoding apparatus comprising:
an intra prediction error collector for collecting prediction errors of blocks having an equal intra prediction mode from macroblocks in a regular unit, which are encoded prior to a current macroblock; and
a transform base generator for generating transform bases for respective intra prediction modes based on the prediction errors collected by the intra prediction error collector,
the transform encoding apparatus transform-encoding the prediction error generated by the intra prediction apparatus by using the transform bases generated by the transform base generator.

5. The transform encoding apparatus of claim 4, wherein the intra prediction error collector collects the prediction errors into a set as defined in an equation of P^{m}={Pₖ^{m}|1≦k≦Nₘ}, where m denotes an index indicating a 4×4 intra prediction mode number, the index having values from 0 to 8, Nₘ denotes a number of blocks in which an intra prediction mode is determined as an intra prediction mode m| among macroblocks in a regular unit which are encoded prior to a current macroblock, P^{m} denotes a 4×4 prediction error block set of the blocks in which the intra prediction mode is determined as the intra prediction mode m among the macroblocks in the regular unit which are encoded prior to the current macroblock, and Pₖ^{m} denotes one 4×4 prediction error block which is a k^{th} element of P^{m}.

6. The transform encoding apparatus of claim 4, further comprising a correlation matrix calculator for calculating an autocorrelation matrix for a set of the prediction errors collected by the intra prediction error collector based on an equation of
$${R}_{c}^{m} = E [ {{P}_{k}^{m} ( {P}_{k}^{m} )}^{T} ] = \frac{1}{{N}_{m}} {\sum }_{k = 1}^{{N}_{m}} {{P}_{k}^{m} ( {P}_{k}^{m} )}^{T} ,$$
where R_{c}^{m} denotes a 4×4 autocorrelation matrix for a column vector signal of a 4×4 intra prediction error in which an intra prediction mode is determined as an intra prediction mode m, m denotes an index indicating a 4×4 intra prediction mode number, the index having values from 0 to 8, Nₘ denotes a number of blocks in which an prediction mode is determined as the intra prediction mode m| among macroblocks in a regular unit which are encoded prior to a current macroblock, and Pₖ^{m} denotes one 4×4 prediction error block which is a k^{th} element of P^{m} denoting a 4×4 prediction error block set of the blocks in which the intra prediction mode is determined as the intra prediction mode m| among the macroblocks in the regular unit which are encoded prior to the current macroblock,
wherein the transform base generator generates transform bases by using a calculated autocorrelation matrix.

7. The transform encoding apparatus of claim 4, further comprising a correlation matrix calculator for calculating an autocorrelation matrix for a set of the prediction errors collected by the intra prediction error collector based on an equation of
$${R}_{r}^{m} = E [ {( {P}_{k}^{m} )}^{T} {P}_{k}^{m} ] = \frac{1}{{N}_{m}} {\sum }_{k = 1}^{{N}_{m}} {( {P}_{k}^{m} )}^{T} {P}_{k}^{m} ,$$
where Rᵣ^{m} denotes a 4×4 autocorrelation matrix for a row vector signal of a 4×4 intra prediction error in which an intra prediction mode is determined as an intra prediction mode m|, m| denotes an index indicating a 4×4 intra prediction mode number, the index having values from 0 to 8, Nₘ denotes a number of blocks in which an intra prediction mode is determined as the intra prediction mode m| among macroblocks in a regular unit which are encoded prior to a current macroblock, and Pₖ^{m} denotes one 4×4 prediction error block which is a k^{th} element of P^{m} denoting a 4×4 prediction error block set of the blocks in which the intra prediction mode is determined as the intra prediction mode m| among the macroblocks in the regular unit which are encoded prior to the current macroblock,
wherein the transform base generator generates transform bases by using a calculated autocorrelation matrix.

8. A transform base generating apparatus for generating transform bases for intra prediction modes, the transform base generating apparatus comprising:
an intra prediction error collector for collecting prediction errors of blocks having an equal intra prediction mode from macroblocks in a regular unit, which are encoded prior to a current macroblock;
a correlation matrix calculator for calculating an autocorrelation matrix for a set of the prediction errors collected by the intra prediction error collector; and
an eigenvector calculator for calculating an eigenvector from the autocorrelation matrix calculated by the correlation matrix calculator,
the transform base generating apparatus generating the transform base for each intra prediction mode based on the eigenvector calculated by the eigenvector calculator.

9. The transform base generating apparatus of claim 8, wherein a KLT-based transform base is generated based on the autocorrelation matrix and the eigenvector.

10. An intra prediction apparatus, comprising:
an intra predictor for predicting a pixel value of a current pixel by using neighboring pixels of a target block within a current frame according to a directional intra prediction mode and generating a prediction error through a difference between a predicted pixel value and the current pixel; and
an intra prediction error collector for collecting prediction errors of blocks having an equal intra prediction mode from macroblocks in a regular unit, which are encoded prior to a current macroblock,
the intra prediction apparatus outputting the prediction errors for the macroblocks in the regular unit, which are encoded prior to the current macroblock, the prediction error being collected by the intra prediction error collector, together with the prediction error generated by the intra predictor for the current frame.

11. A video decoding apparatus, comprising:
an intra prediction error collector for collecting prediction errors of blocks having an equal intra prediction mode from macroblocks in a regular unit, which are encoded prior to a current macroblock;
a transform base generator for generating transform bases for respective intra prediction modes based on the prediction errors collected by the intra prediction error collector;
an intra prediction mode reader for reading an intra prediction mode of a target block to be decoded for an input bitstream;
an inverse transformer for inversely transforming a prediction error for the target block by using a transform base corresponding to the intra prediction mode read by the intra prediction mode reader among the transform bases generated by the transform base generator; and
a current block reconstructer for predicting a pixel value of a current pixel by using neighboring pixels of the target block within a current frame according to the intra prediction mode read by the intra prediction mode reader and reconstructing a current block by adding a predicted pixel value and a value of the prediction error inversely transformed by the inverse transformer.

12. The video decoding apparatus of claim 11, wherein the transform base generator comprises:
a correlation matrix calculator for calculating an autocorrelation matrix for a set of the prediction errors collected by the intra prediction error collector; and
an eigenvector calculator for calculating an eigenvector from the autocorrelation matrix calculated by the correlation matrix calculator,
the video decoding apparatus generating a KLT-based transform base based on the autocorrelation matrix and the eigenvector.

13. A video encoding method, comprising:
collecting prediction errors of blocks having an equal intra prediction mode from macroblocks in a regular unit, which are encoded prior to a current macroblock, and predicting a value of a current pixel by using neighboring pixels of a target block according to a directional intra prediction mode for a current frame and generating a prediction error through a difference between a predicted value and the value of the current pixel;
generating transform bases for respective intra prediction modes based on the prediction errors collected in collecting of the prediction errors; and
transform-encoding the prediction error generated for the current frame by using the transform bases generated in generating of the transform bases.

14. A transform encoding method of transforming and encoding a prediction error generated by a difference between a pixel predicted by an intra prediction apparatus and a current pixel, the transform encoding method comprising:
collecting prediction errors of blocks having an equal intra prediction mode from macroblocks in a regular unit, which are encoded prior to a current macroblock;
generating transform bases for respective intra prediction modes based on the prediction errors collected in collecting of the prediction errors; and
transform-encoding the prediction error generated by the intra prediction apparatus by using the transform bases generated in generating of the transform bases.

15. The transform encoding method of claim 14, further comprising:
calculating an autocorrelation matrix for a set of the prediction errors collected in collecting of the prediction errors,
wherein generating of the transform bases generates the transform bases by using a calculated autocorrelation matrix.

16. A video decoding method, comprising:
collecting prediction errors of blocks having an equal intra prediction mode from macroblocks in a regular unit, which are encoded prior to a current macroblock;
generating transform bases for respective intra prediction modes based on the prediction errors collected in collecting of the prediction errors;
reading an intra prediction mode of a target block to be decoded for an input bitstream;
inversely transforming a prediction error for the target block by using a transform base corresponding to the intra prediction mode read in reading of the intra prediction mode among the transform bases generated in generating of the transform bases; and
predicting a pixel value of a current pixel by using neighboring pixels of the target block within a current frame according to the intra prediction mode read in reading of the intra prediction mode and reconstructing a current block by adding a predicted pixel value and a value of the prediction error inversely transformed in inversely transforming of the prediction error.

17. The video decoding method of claim 16, wherein generating of the transform bases comprises:
calculating an autocorrelation matrix for a set of the prediction errors collected in collecting of the prediction errors; and
calculating an eigenvector from the autocorrelation matrix calculated in calculating of the correlation matrix,
wherein a KLT-based transform base is generated based on the autocorrelation matrix and the eigenvector.
